(19) United States
(12) Patent Application Publication
(10) Pub. No.: US 2006/0041668 A1
(43) Pub. Date: Feb. 23, 2006

(54) METHOD AND SYSTEM TO AUTOMATICALLY DEFINE RESOURCES FORMING AN IT SERVICE

(75) Inventors: John E. Dinger, Cary, NC (US); Bradford A. Fisher, Chapel Hill, NC (US); Robert T. Uthe, Morrisville, NC (US)

Correspondence Address: MOORE & VAN ALLEN, PLLC, P.O. Box 13706, Research Triangle Park, NC, 27709, US

(73) Assignee: INTERNATIONAL BUSINESS MACHINES CORPORATION, Armonk, NY (US)

(21) Appl. No.: 10/711,956

(22) Filed: Oct. 15, 2004

Related U.S. Application Data
(63) Continuation-in-part of application No. 10/711,042, filed on Aug. 19, 2004.

(51) Int. Cl. G06F 15/16

(52) U.S. Cl. 709/229

(57) ABSTRACT

A method to automatically define resources forming an IT service may include tracking resources utilized in responding to a request or set of requests or performing a transaction or a set of transactions. The method may also include automatically defining resources that form an IT service by aggregating all resources utilized to respond to all requests or to perform all transactions.

### CROSS REFERENCE TO RELATED APPLICATIONS

This application is a continuation-in-part to co-pending patent application Ser. No. 10/711,042, filed Aug. 19, 2004, entitled “Method and System to Evaluate Utilization of Resources,” which is incorporated herein in its entirety by reference and is assigned to the same assignee as this application.

### BACKGROUND OF INVENTION

The present invention relates to information technology (IT) services and more particularly to a method and system to automatically define resources forming or comprising an IT service or the like.

There is a need to provide system management products that provide an ability to automatically understand or define the inter-relationships between various software, hardware, storage devices and other components that may collectively provide an IT service to its owning company. An IT service may also be referred to as a Business System, Line of Business or Business Service. With current products, an administrator must manually associate the specific IT resources into a collection that define an IT service. Another option or alternative is to be able to define simple rules which perform a query against all resources. The resources matching the query are then placed into a collection (IT Service, Business System, etc.). While this option may be better than the manual method, this option does not work well in practice because it requires conventions be followed in how the IT resources are defined or identified so that general queries may be used. For example, queries against a resource name are only useful when an IT organization has strict naming conventions that are followed religiously.

While either the manual method or defined rules method above may permit an operator or administrator to view and understand the IT resources that form or comprise an IT service, the IT resources included to define the service are only as complete as the last time the administrator manually re-evaluated the IT service's contents, or as complete as the accuracy of the rules and frequency with which they are processed.

### SUMMARY OF INVENTION

Being able to discover or define the resources that a given IT service comprises may provide a significant competitive advantage. In accordance with an embodiment of the present invention, a method to define resources that comprise or form an IT service may include recording a total set of resources employed or utilized in responding to a request or performing a transaction, such as an Application Resource Monitoring (ARM) based transaction or the like, during a selected time period or rolling time period. In addition to the ability to automatically define the resources forming an IT service, the resources that are used the most during the selected time period or rolling time period may be assigned a higher priority than those used less frequently. In this manner, not only can the IT service be discovered or defined, but the service's status propagation logic may be influenced or adjusted to a higher degree when one of the service's higher priority resources encounters a problem.

In accordance with an embodiment of the present invention, a method to automatically define resources forming an IT service may include tracking resources utilized in responding to a request or set of requests or performing a transaction or set of transactions. The method may also include automatically defining resources that form an IT service by aggregating all resources utilized to respond to all requests or to perform all transactions.

In accordance with an embodiment of the present invention, a method to automatically define resources forming an IT service may include examining each instance of a request or transaction. The method may also include maintaining a record of a union of all resources utilized in responding to each instance of a request or transaction over a selected time period or on a rolling time period basis.

In accordance with an embodiment of the present invention, a system that automatically defines resources forming an IT service may include a processor. The system may also include a resource utilization program operable on the processor. The resource utilization program may include computer executable instructions to maintain a record of a union of all resources utilized in responding to each instance of a request or transaction over a selected time period or on a rolling time period basis.

In accordance with an embodiment of the present invention, a method of making a system that automatically defines resources forming an IT service may include providing a processor. The method may also include providing a resource utilization program operable on the processor. The resource utilization program may include computer executable instructions to maintain a record of a union of all resources utilized in responding to each instance of a request or transaction over a selected time period or on a rolling time period basis.

In accordance with another embodiment of the present invention, a computer-readable medium having computer-executable instructions for performing a method that may include tracking resources utilized in responding to a request or set of requests or performing a transaction or set of transactions. The method may also include automatically defining resources that form an IT service by aggregating all resources utilized to respond to all request or to perform all transactions.

### BRIEF DESCRIPTION OF DRAWINGS

FIG. 1 is a illustration of an example of responses to a set of requests or performance of a set of transactions and the resources that may be sequenced together to fulfill each request or perform each transaction.

FIGS. 2A and 2B (collectively FIG. 2) are a flow chart of an example of a method to automatically define resources forming an IT service in accordance with an embodiment of the present invention.

FIG. 3 is an example of a resource utilization diagram in accordance with an embodiment of the present invention.

FIG. 4 is an example of a system that may automatically define resources forming an IT service in accordance with an embodiment of the present invention.

### DETAILED DESCRIPTION

The following detailed description of preferred embodiments refers to the accompanying drawings which illustrate specific embodiments of the invention. Other embodiments having different structures and operations do not depart from the scope of the present invention.

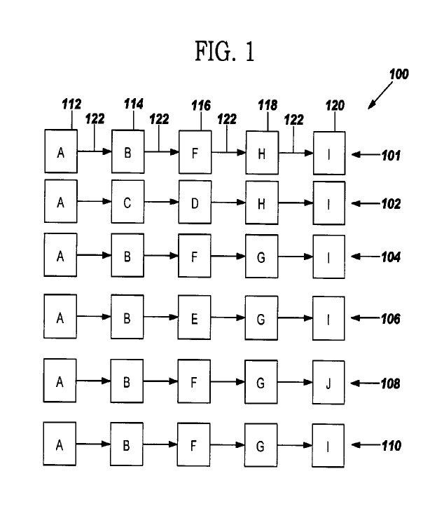

FIG. 1 is an illustration of an example of a resource utilization diagram 100 illustrating responses to a set of requests or performance of a set of transactions and the resources that may be sequenced together to fulfill each request or perform each transaction. Each line or sequence 101-110 represents a response to a request or performance of a transaction, such as an ARM-instrumented transaction, and the resources that may be used to satisfy the request or perform the transaction. The different lettered boxes correspond to different resources 112-120 utilized to satisfy the request or perform the transaction and the arrows 122 between the lettered boxes correspond to paths between the different resources 112-120. Examples of resources 112-120, and sequences of resource usages, may be information technology (IT) resources, such as networking adapters, routers or the like, which in sequence pass data back and forth to provide a communication session between two applications, or resources such as servlets that make up a web site where a user navigates through a sequence of servlets. In these examples a unique request may be a data packet being sent between two applications, or a user session with the web application. To fulfill the request or perform a transaction, a set of resources are utilized in a sequence, where the given sequence can quite likely change when processing subsequent requests or transactions.

The resource utilization diagram 100 presented in FIG. 1 may be used to present each transaction to a user or requestor for analysis. The diagram 100 may be used to represent the multiple resources 112-120 in a system 100 or needed to provide a service. Accordingly, the resources 112-120 can be discovered or defined and an understanding of the specific resources 112-120 that were exercised to complete a specific transaction may be gained.

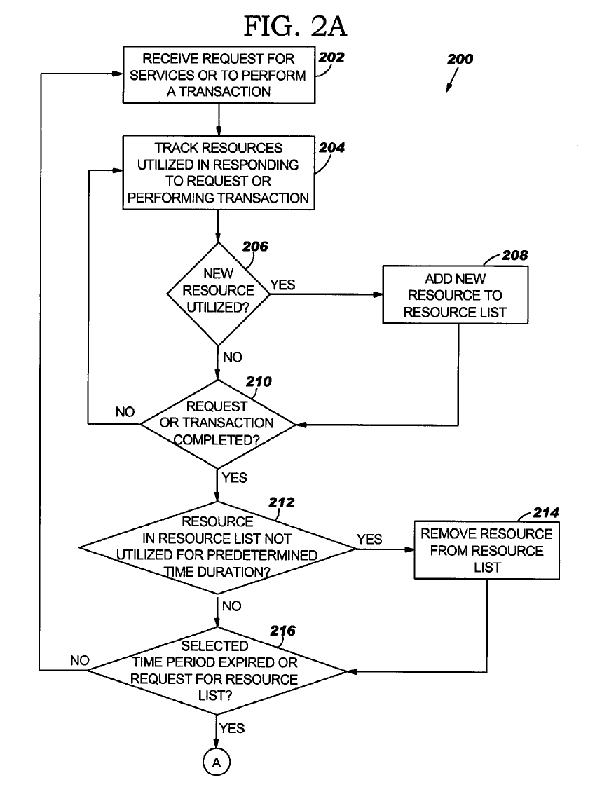

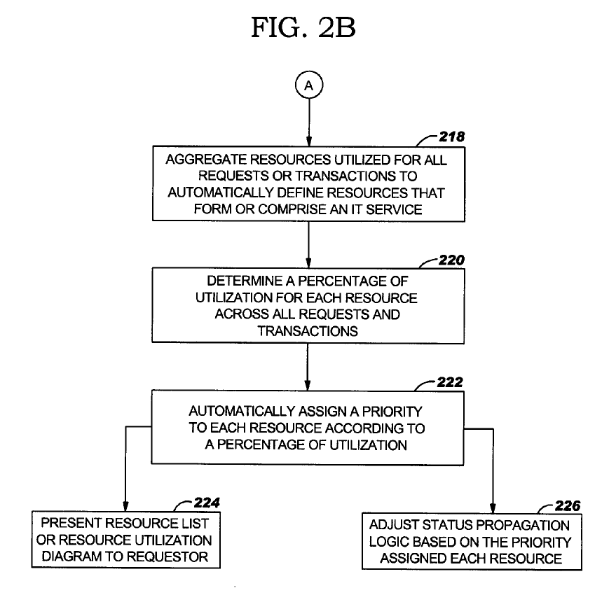

FIGS. 2A and 2B (collectively FIG. 2) are a flow chart of an example of a method 200 to automatically define resources forming an IT service. In block 202, a request may be received for a service or to perform a transaction. In block 204, resources utilized in responding to the request or performing the transaction may be tracked or each instance of a request or transaction may be examined or monitored. In tracking the resources or examining each instance of a request or transaction, a determination may be made in block 206 if any new or unknown resources are utilized that previously have not been used or are not on a resource list. The resource list may include any resources that have been used during a selected time period or a rolling time period. If the resource being used is new or unknown in block 206, the new resource may be added to the resource list in block 208. If the resource has been used before and is in the resource list in block 206, the method 200 may advance to block 210. In block 210, a determination may be made whether the request or transaction has been completed. If the request or transaction has not been completed, the method 200 returns to block 204 and the method 200 continues to track the resources as previously described. If the request or transaction is completed in block 210, the method may advance to block 212. In block 212, a determination may be made if any resources in the resource list have not been utilized for a predetermined time duration. Any resource not used for the predetermined time period in block 212 may be removed from the list in block 214. The method 200 may advance to block 216 from block 214 if the response in block 212 is no. Note that the processing at block 212 may be driven on a regular interval such that resources can be “aged” out even when no requests or transactions are arriving.

In block 216, a determination may be made if a selected time period or rolling time period has expired or if the resource list has been requested. If the selected time period or rolling time period has not expired or the request list not requested, the method 200 may return to block 202 where another request for service or a transaction may be received. The method 200 may then proceed as described above. If the selected time period or rolling time period has expired or a request for the resource list received, the method 200 may advance to block 218. In block 218, all of the resources for all requests or transactions may be aggregated to automatically define the resources that form or comprise an IT service. The resources may be aggregated from the resource list. The resource list may form a record of the union of all resources utilized during the selected time period or rolling time period.

In block 220 a percentage of utilization for each resource across all requests and transactions for the selected or rolling time period may be calculated in order to determine which resources are used more frequently than others. In block 222, a priority may automatically be assigned to each resource according to the percentage of utilization in block 220. In block 224, the resource list or a resource utilization diagram or both may be presented to a user or requester. The resource list and resource utilization diagram may also include or represent the percentage of utilization and priority for each resource. At any given point, the current resource list may represent the resources used by a given transaction or group of transactions. A group of transactions and their corresponding resources may be aggregated together as described with respect to block 218 to automatically define the resources that form or comprise an IT service.

In block 226, the priority assigned to each resource in block 222 may be used to adjust or influence status propagation logic associated with the IT service for more efficient operation of the service. For example, if a higher priority resource is experiencing a problem, status propagation logic will cause the IT service to show its status as degraded thereby, informing users that a significant problem exists. An example of status propagation logic is described in U.S. Pat. No. 5,535,335, entitled “Method and System for Reporting the Status of an Aggregate Resource Residing in a Network of Interconnected Real Resources” by David E. Cox et. al., which is assigned to the same assignee as the present invention and incorporated herein in its entirety by reference. The priorities and utilization percentages may also be helpful in planning maintenance operations and making improvements to the service, such as providing extra capacity or redundancy of higher priority resources or the like.

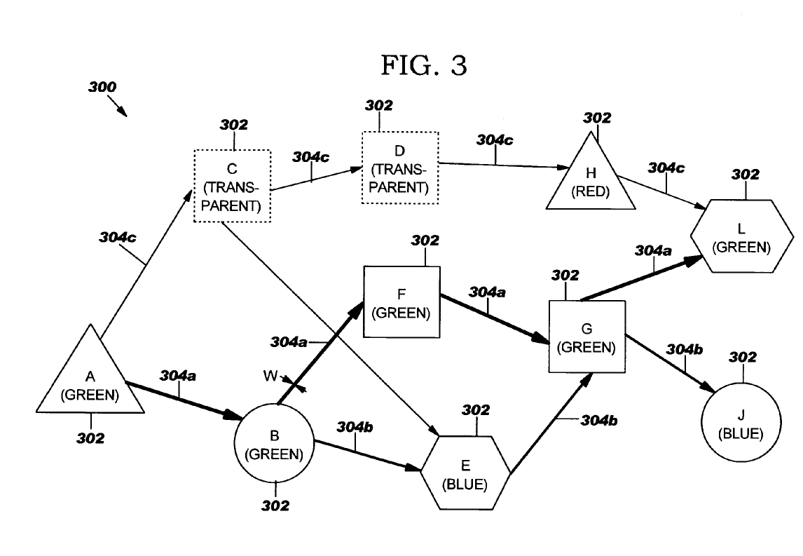

FIG. 3 is an example of a resource utilization diagram 300 in accordance with an embodiment of the present invention. The resource utilization diagram may be formed as a result of the method 200 of FIGS. 2A and 2B or as described in U.S. patent application Ser. No. 10/711,042 filed Aug. 19, 2004 and entitled “Method and System to Evaluate Utilization of Resources.” The diagram 300 may represent a sequence of utilization of a plurality of resources, such as network adapters, routers, web sites, database servers and the like, that may be accessed or utilized in responding to a request or a set of requests for information or data. Each of the resources may be represented by a predetermined resource symbol 302 in diagram 300. Each segment or path between resources may be represented by a line 304 between sequential resource symbols 302. Each line 304 may have a selected line width “W” corresponding to a quantity or number of occurrences of the segment in responding to a request or set of requests. For example, a higher quantity of occurrences of each segment between resources may correspond to a wider selected width “W” of the line 304 compared to a lower quantity of occurrences of a segment. To further illustrate this feature, lines 304a have the widest selected width and represent segments with the highest quantity of occurrences. Lines 304c have the narrowest selected width and represent segments with the lowest quantity of occurrences in the sequence and lines 304b have a selected width between the widths of lines 304a and 304c illustrating an intermediate quantity of occurrences of the segments represented by these lines. Similarly, resources 302 could be enlarged to convey a high usage, or shrunk to covey seldom use. The diagram 300 may represent a utilization of resources in responding to a request or set of request or performing a transaction or set of transactions over a predetermined time period or rolling time period.

Each resource symbol 302 may be represented with a predetermined attribute that may correspond to a status of the resource, type of resource or other feature or parameter related to the resource. As illustrated in FIG. 3, examples of these predetermined attributes may include a shape of the resource symbol 302, a color of the resource symbol, as illustrated parenthetically in each resource symbol, or similar indication. The attribute may represent a type of resource, a resource status (active or inactive) or similar condition.

The resource utilization diagram 300 may represent the same set of resources used by the transactions in the resource utilization diagram 100 of FIG. 1. In diagram 300 it is immediately apparent which resources are used the most within a resource set and may be assigned a correspondingly higher priority for certain purposes, such as status propagation to the IT services the resource participates in, and in operational and maintenance purposes, as described above. The percentages of utilization and assigned priorities may also be displayed in the diagram 300, in a tabular form or other suitable format.

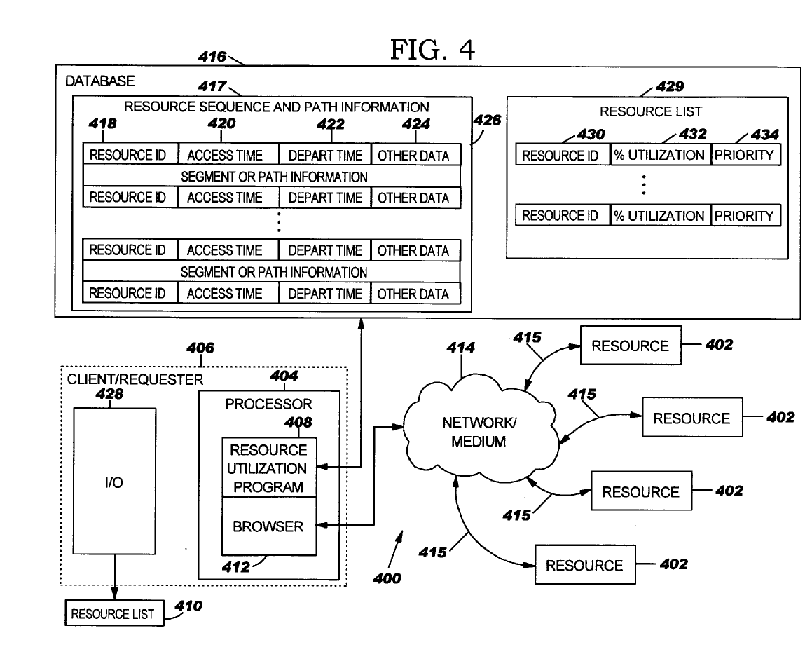

FIG. 4 is an example of a system 400 to evaluate utilization of resources 402 in accordance with an embodiment of the present invention. The system 400 may include a processor 404 that may be accessed by a user or requestor 406. A resource utilization program 408 may operate on the processor 404. The resource utilization program 408 may embody elements of the method 200 described with respect to FIGS. 2A and 2B to present a resource list 410, a resource utilization diagram, such as the diagram 100 of FIG. 1 or the diagram 300 illustrated in FIG. 3, or some other representation of resource utilization. Accordingly, the resource utilization program 408 may include computer executable instructions or the like to track a sequence of utilization of a plurality of resources 402 in responding to a request or set of requests similar to that described with respect to method 200. The resource utilization program 408 may also include computer executable instructions or the like to determine a quantity of occurrences of each segment linking pairs of resource in the sequence. The resource utilization program 408 may also include computer executable instructions or the like to generate a resource utilization representation, such as diagram 300 of FIG. 3 or the like, including a representation of the quantity of occurrences of each segment linking the resources. The resource utilization program 408 may also include computer executable instructions to examine each instance of a request or transaction and to maintain a record of a union of all resources utilized in responding to each instance of a request or transaction over a selected time period or on a rolling time period in order to automatically associate those resources with a given IT service.

The system 400 or resource utilization program 408 may also include computer executable instruction or the like to represent each resource by a predetermined symbol, such as symbols 302 of FIG. 3 or similar representations. The system 400 or resource utilization program 408 may also include computer executable instructions to represent each segment or path between or linking resources 402 by a line between corresponding resource symbols similar to that illustrated in FIG. 3 by lines 304. The utilization program 408 may further include computer executable instructions to form each line with a selected line width that may correspond to the quantity of occurrences of the segment in responding to the request or set of requests similar to that described with respect to FIG. 3.

The system 400 or resource utilization program 408 may also include means, computer executable instructions or the like to represent each resource symbol at a predetermined level or degree of translucency corresponding to a time duration since the resource corresponding to the resource symbol was last utilized or accessed. Computer executable instructions may also be provided to represent each resource with a predetermined attribute corresponding to a different possible status of the resource or other information related to the resource. The predetermined attribute may involve coloring each resource symbol one of a plurality of different predetermined colors, or forming each resource symbol in one of a plurality of predetermined shapes, depending upon the status or attribute being illustrated, similar to that described with respect to FIG. 3. Other means or techniques may be used as well to visually designate or distinguish between different attributes or statuses.

The system 400 may also include a browser 412 operable on the processor 404 to access the resources 402 to respond to a request or set of requests or perform a transaction. The browser 412 may access the resources 402 via a network 414 which may form the segments 415 or paths between the resources 402 as described above. The network 414 may be any communication network, such as the Internet, private network or the like. The browser 412 may be Netscape®, Microsoft Internet Explorer® or the like. The resource utilization program 408 may operate in association with the browser 412 to track a sequence of utilization of the plurality of resources 402 in responding to a request or a set of requests or performing a transaction or set of transactions.

A database 416 may be provided to store resource sequence and path information 417. The resource sequence and path information 417 may sequentially store a resource identification (ID) 418 for each resource 402 that may be accessed or utilized in response to a request or set of requests or to perform a transaction or set of transactions. The resource sequence and path information 417 may also store an access time 420 when the resource 402 was accessed or utilized. The database 416 may also store a departure time 422 when the browser 412 departs a current resource 402 or transitions to another resource 402 and may store any other data 424 that may assist in evaluating utilization of resources in a system or network. The resource sequence and path information may further store segment or path information 426 so that the number or quantity of occurrences of a segment may be determined.

Input and output devices 428 or combination I/O devices may be coupled to the processor 404 to permit the user 406 or requester to operate and interface with the processor 404. The I/O devices 428 may include a keyboard and pointing device to enter requests and a display or monitor to present resource utilization information to the user 406 or requester, such as the resource list 410 or the resource utilization diagram 300 illustrated in FIG. 3 or the like. The I/O devices 428 may also include disk drives, optical, mechanical, magnetic, or infrared input/output devices or the like.

In accordance with an embodiment of the present invention, the database 416 may store a resource list 429. The resource list 429 may be the same as the resource list 410. A new or unknown resource 402 may be added to the resource list 429 whenever a new or unknown resource is utilized in responding to a request or set of requests or in performing a transaction or set of transactions, similar to that described with respect to block 208 of method 200 (FIG. 2). The resource list 429 may include a resource ID 430 to identify each of the resources 402 on the list 429. The resource list 429 may also include a percentage of utilization 432 of each resource 402 on the list 429 in responding to a request or set of requests or performing transactions during a selected time period or during a rolling time period as previously described with respect to method 200 (FIG. 2). The percentage of utilization may be determined by the resource utilization program 408 from the resource sequence and path information 417. The resource list 429 may further include a priority 434 that may be automatically assigned to each resource 402 in the list 429 according to the percentage of utilization of the resource 402. The priority may be automatically assigned by the resource utilization program 408.

Elements of the present invention, such as method 200 of FIGS. 2A and 2B, and system 400 of FIG. 4, may be embodied in hardware and/or software as a computer program code that may include firmware, resident software, microcode or the like. Additionally, elements of the invention may take the form of a computer program product on a computer-usable or computer-readable storage medium having computer-usable or computer-readable program code embodied in a medium for use by or in connection with a system, such as system 400 of FIG. 4. Examples of such a medium may be illustrated in FIG. 4 as network or medium 414 and I/O devices 428. A computer-usable or readable medium may be any medium that may contain, store, communicate or transport the program for use by or in connection with a system. The medium, for example, may be an electronic, magnetic, optical, electromagnetic, infrared or semiconductor system or the like. The medium may also be simply a stream of information being retrieved when the computer program product is “downloaded” through a network, such as the Internet or the like. The computer-usable or readable medium could also be paper or another suitable medium upon which the program may be printed.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method to automatically define resources forming an IT service, comprising:
tracking resources utilized in responding to a request or set of requests or performing a transaction or a set of transactions; and
automatically defining resources that form an IT service by aggregating all resources utilized to respond to all requests or to perform all transactions.

2. The method of claim 1, further comprising adding any new resources utilized to a resource list.

3. The method of claim 2, further comprising removing any resource from the resource list in response to the resource not being utilized for a predetermined time duration.

4. The method of claim 1, further comprising determining a percentage of utilization of each resource across all requests or transactions.

5. The method of claim 4, further comprising automatically assigning a priority to each resource according to the percentage of utilization of the resource.

6. The method of claim 5, further comprising presenting a resource list and an associated priority for each resource to a user or requestor.

7. The method of claim 5, further comprising adjusting a status propagation logic based on the priority assigned to each resource.

8. The method of claim 1, further comprising presenting a resource utilization diagram to a user or requestor.

9. The method of claim 8, further comprising representing a percentage of utilization of each resource in the resource utilization diagram.

10. The method of claim 9, further comprising representing a priority of each resource in the resource utilization diagram, wherein the priority is automatically assigned according to the percentage of utilization of the resource.

11. The method of claim 8, further comprising representing a quantity of occurrences of each segment linking resources in the resource utilization diagram.

12. The method of claim 8, further comprising representing a time duration since each resource was last utilized in the resource utilization diagram.

13. A method to automatically define resources forming an IT service, comprising:
examining each instance of a request or transaction; and
maintaining a record of a union of all resources utilized in responding to each instance of a request or transaction over a selected time period or on a rolling time period basis.

14. The method of claim 13, further comprising determining a percentage of utilization of each resource across all requests or transactions.

15. The method of claim 14, further comprising automatically assigning a priority to each resource according to the percentage of utilization of the resource.

16. The method of claim 14, further comprising adjusting a status propagation logic based on the priority assigned to each resource.

17. The method of claim 13, further comprising presenting a resource utilization diagram to a user or requestor.

18. A system that automatically defines resources forming an IT service, comprising:
a processor; and
a resource utilization program operable on the processor, wherein the resource utilization program includes computer executable instructions to maintain a record of a union of all resources utilized in responding to each instance of a request or transaction over a selected time period or on a rolling time period basis.

19. The system of claim 18, wherein the resource utilization program comprises computer executable instructions to determine a percentage of utilization of each resource across all request or transactions.

20. The system of claim 19, wherein the resource utilization program comprises computer executable instructions to automatically assign a priority to each resource according to the percentage of utilization of the resource.

21. The system of claim 18, wherein the resource utilization program comprises computer executable instructions to adjust a status propagation logic based on the priority assigned to each resource.

22. The system of claim 18, wherein the resource utilization program comprises executable instruction to present a resource utilization diagram to a user or requestor.

23. A method of making a system that automatically defines resources forming an IT service, comprising:
providing a processor; and
providing a resource utilization program operable on the processor, wherein the resource utilization program includes computer executable instructions to maintain a record of a union of all resources utilized in responding to each instance of a request or transaction over a selected time period or on a rolling time period basis.

24. The method of claim 23, further comprising providing computer executable instructions to determine a percentage of utilization of each resource across all request or transactions.

25. The method of claim 24, further comprising providing computer executable instructions to automatically assign a priority to each resource according to the percentage of utilization of the resource.

26. The method of claim 23, further comprising providing computer executable instructions to adjust a status propagation logic based on the priority assigned to each resource.

27. The method of claim 23, further comprising providing computer executable instructions to present a resource utilization diagram to a user or requestor.

28. A computer-readable medium having computer-executable instructions for performing a method, comprising:
tracking resources utilized in responding to a request or set of requests or performing a transaction or a set of transactions; and
automatically defining resources that form an IT service by aggregating all resources utilized to respond to all requests or to perform all transactions.

29. The computer-readable medium having computer executable instructions for the method of claim 28, further comprising automatically assigning a priority to each resource according to the percentage of utilization of the resource.

30. The computer-readable medium having computer executable instructions for performing the method of claim 29, further comprising presenting a resource list and an associated priority for each resource to a user or requestor.

31. The computer-readable medium having computer executable instructions for performing the method of claim 29, further comprising adjusting a status propagation logic based on the priority assigned to each resource.

32. The computer-readable medium having computer executable instructions for performing the method of claim 28, further comprising presenting a resource utilization diagram to a user or requestor.
